(19) United States
(12) Patent Application Publication
(10) Pub. No.: US 2002/0178649 A1
(43) Pub. Date: Dec. 5, 2002

(54) Racquet for killing flying insects

(76) Inventor: Keith M. Betzen, Unionville, IN (US)

Correspondence Address: Keith M. Betzen, P.O. Box 5604, Bloomington, IN, 47407-5604, US

(21) Appl. No.: 09/872,992

(22) Filed: Jun. 2, 2001

(51) Int. Cl. A01M 3/02; A01M 5/02

(52) U.S. Cl. 43/137

(57) ABSTRACT

A means to kill or disable flying insects is provided having a lightweight, long-handled racquet, similar to a badminton racquet, with the elliptical hoop of the racquet being woven with tightly stretched, small diameter wire or other inelastic filaments and with the adjacent wires being spaced closely so that a flying insect will be hit by one or more of the strands when the racquet is swung to hit the insect. The small diameter wire is difficult for the insect to see and it does not build up an advance air pressure wave which might warn the insect to avoid the approaching racquet or move the insect out of the path of the racquet. The rigid racquet and the tightly stretched, relatively inelastic wire effectively convey the momentum of the racquet to the small area of the wire that hits the insect and so delivers a concentrated blow that is very damaging to the insect. The device can be used to control the flying insect population, indoors or outdoors, without the use of insecticides.

### FIELD OF THE INVENTION

This invention relates to flying insect control devices, particularly to a hand-held racquet device designed to kill or disable an insect in flight by hitting it with the small diameter filaments stretched onto the racquet.

### BACKGROUND OF THE INVENTION

Various types of hand-held devices have been presented for the control of flying insects.

Insect swatters could possibly be used to hit an insect in flight, but swatter heads, being designed to kill insects sitting on a relatively hard surface, are necessarily flexible making them less useful against insects in flight. Although swatter heads are perforated they generally have a large relative surface area intended to crush the insect. This large surface area makes the swatter easy for a flying insect to see and avoid, and it creates an advance air pressure wave when the swatter is moved rapidly, warning the insect and pushing it out of the way. Many variations of swatters have been presented with modifications incorporating springs, traps, hooks, spikes, adhesives and insecticides. Nevertheless, insect swatters, even if made larger, would be very difficult to use to kill or disable insects in flight.

Insect catching nets are shown by U.S. Pat. Nos. 115,374 to Sohier (1871) and 404,946 to Andersson (1889). While a net can be useful to catch insects in flight, nets do not kill or disable the insect and they are difficult to use because the long tail of the net does not change direction quickly as is necessary to follow and catch an insect in erratic flight.

A mechanical trap with louvered doors which is designed to be swung through the air and entrap insects is described by U.S. Pat. No. 499,722 to Edge (1893). This device is mechanically complicated and bulky and would not move through the air easily.

U.S. Pat. No. 984,332 to Whitehead (1911) shows an insect killer that is a tapered coil of wire formed into a secondary loop and attached to a handle. The wire coil shown is not rigid and would flex when moved rapidly to hit a flying insect, so a higher speed would be required and the damage done to the insect would be unpredictable. Also, this device would yield variable results because the spacing between the loops of wire is not constant and the surface which hits the insect has a changing angle.

U.S. Pat. No. 798,825 to Petersen (1905) shows a fly and mosquito gun that shoots an expansible dart intended to entrap an insect. This device is mechanically complicated and would require extraordinary skill to entrap a flying insect.

U.S. Pat. Nos. 1,059,736 to Kilduff (1913) and 1,616,483 to Bell (1927) show pistol devices that shoot a captive elastic strip or a rubber band to kill insects. These devices would be virtually impossible to use to hit a flying insect.

U.S. Pat. No. 2,604,723 to Bennett (1952) shows a live cricket catcher which could be swung through the air to hit flying insects. However, the mesh covering the hoop balloons outward to be larger than the opening of the hoop. Since it is not stretched tightly, the flexible mesh would not fully convey the energy of the moving catcher to the insect that is struck. The device has a small hoop and a short handle so it would be difficult to move rapidly through the air and hit a flying insect.

Hand-held suction devices to capture insects are described by U.S. Pat. Nos. 1,308,497 to Jolly (1919) and 3,965,608 to Schuman (1976). These devices are mechanically complicated and would have very limited use against flying insects because it would be extremely difficult to hold the nozzle of the device close enough to a rapidly moving insect.

U.S. Pat. No. 4,132,027 to Malacheski (1979) shows a mechanically complicated device intended to capture an insect by scooping it into a spring loaded cone which then conveys the insect to a container. It would be very difficult to capture an insect in flight with this device.

U.S. Pat. Nos. 5,519,963 to Shih (1996) and 5,533,298 to Teng (1996) show hand-held electric bug killers. To function these devices require that the insect make simultaneous contact with two electrodes. Also, these types of devices require batteries and a transformer circuit making them heavy and difficult to move rapidly enough to make contact with an insect in flight.

Various flying insect control devices that use an adhesive to trap and hold an insect have been described. U.S. Pat. Nos. 1,623,006 to Hamborg (1927), 4,089,132 to McLaughlin (1978) and 4,787,171 to Dagenais (1988) show conical or domed insect catchers with the inside of the cone or dome being covered with adhesive. U.S. Pat. No. 5,630,290 to Wade (1997) shows a bug collection apparatus that is essentially a sticky racquet. There are many problems associated with using an adhesive for holding an insect. The adhesive must remain the right consistency or it may run or dry out. Upholstery, hair and other things may become stuck, and some adhesives may be toxic.

An ordinary badminton racquet might be used to kill or disable flying insects, but the mesh has spaces between the filaments that are large enough to allow a small insect to pass through unharmed. The filaments in a badminton racquet are of a larger diameter which makes the racquet quite visible. Also, the somewhat elastic filaments are stretched less tightly and so they remain elastic since their purpose is to protect the shuttlecock as well as return it. These features reduce the usefulness of badminton racquets for killing or disabling flying insects.

It is evident that all of the prior art devices disclosed herein suffer from various disadvantages which limit their efficiency to kill or disable insects in flight.

### SUMMARY OF THE INVENTION

Accordingly, various objects and features of the device of the present invention are described subsequently which include improvements over the prior art devices for hand-held, flying insect control devices.

The principal object of the present invention is to provide a means to kill or disable flying insects, having a light-weight, long-handled racquet, similar to a badminton racquet, with the elliptical hoop of the racquet being woven with closely spaced, tightly stretched, small diameter wire or other filaments, and which strands of wire are spaced so closely as to insure that even a small flying insect will be hit by one or more of the strands when the racquet is swung to hit the flying insect.

Another object of the present invention is to provide a means to kill or disable flying insects, having a light-weight, long-handled racquet, similar to a badminton racquet, with the elliptical hoop of the racquet being woven with closely spaced, tightly stretched, small diameter wire or other filaments, and which wires have a relative very small diameter and a relative large amount of space between them, causing the device to be able to be moved through the air very easily without building up an advance air pressure wave which would warn the insect of the approaching racquet or move the insect out of the path of the racquet.

Another object of the present invention is to provide a means to kill or disable flying insects, having a light-weight, long-handled racquet, similar to a badminton racquet, with the elliptical hoop of the racquet being woven with closely spaced, tightly stretched, small diameter wire or other filaments, and having the racquet handle and hoop being rigid and having the stretched tightly wire to become essentially rigid with the hoop and which rigidity serves to effectively transfer the momentum of the moving racquet precisely to the point of contact between the tightly stretched wires and the insect.

Another object of the present invention is to provide a means to kill or disable flying insects having a light-weight, long-handled racquet, similar to a badminton racquet, with the elliptical hoop of the racquet being woven with closely spaced, tightly stretched, small diameter wire or other filaments, and which filaments are inelastic, or stretched so tightly as to become inelastic, and so do not cushion the blow of the racquet to the insect, allowing the delivery of a concentrated and damaging blow to the insect

Another object of the present invention is to provide a means to kill or disable flying insects having a light-weight, long-handled racquet, similar to a badminton racquet, with the elliptical hoop of the racquet being woven with closely spaced, tightly stretched, small diameter wire or other filaments, which very small diameter wire is difficult for the insect to see and avoid.

Another object of the present invention is to provide a means to kill or disable flying insects having a light-weight, long-handled racquet, similar to a badminton racquet, with the elliptical hoop of the racquet being woven with closely spaced, tightly stretched, small diameter wire or other filaments, and which device uses no adhesives, no insecticides, no batteries, and is not complicated mechanically.

Another object of the present invention is to provide a means to kill or disable flying insects having a light-weight, long-handled racquet, similar to a badminton racquet, with the elliptical hoop of the racquet being woven with closely spaced, tightly stretched, small diameter wire or other filaments, which device provides a means to kill an insect in flight, without having to wait for it to land in a spot where it can be swatted.

Another object of the present invention is to provide a means to kill or disable flying insects having a light-weight, long-handled racquet, similar to a badminton racquet, with the elliptical hoop of the racquet being woven with closely spaced, tightly stretched, small diameter wire or other filaments, and with the device functioning to kill or disable a flying insect using the force of the momentum of the racquet hitting the inertia of the insect. After the initial impact, the insect is moved through the air without being further eviscerated and making a mess.

Therefore, it can be seen that the innovation of the present invention improves the technology previously described for killing or disabling an insect in flight. The combination of features incorporated into the device of the present invention solves prior problems associated with this type of device. It can also be seen that the device of the present invention for killing or disabling an insect in flight produces new and unobvious results that have not been produced by the prior art.

Additional features will become apparent from a consideration of the ensuing drawings and description.

### DESCRIPTION OF THE DRAWINGS

FIG. 1 shows a typical embodiment of the present invention.

FIG. 2 shows an enlarged portion of the elliptical hoop of the racquet.

### DESCRIPTION OF THE PREFERRED EMBODIMENT

The racquet means for killing or disabling flying insects of the present invention may vary widely in its configuration and composition. The preferred embodiment described herein can easily be made with readily available equipment, technology and materials presently used to make badminton and other string racquets.

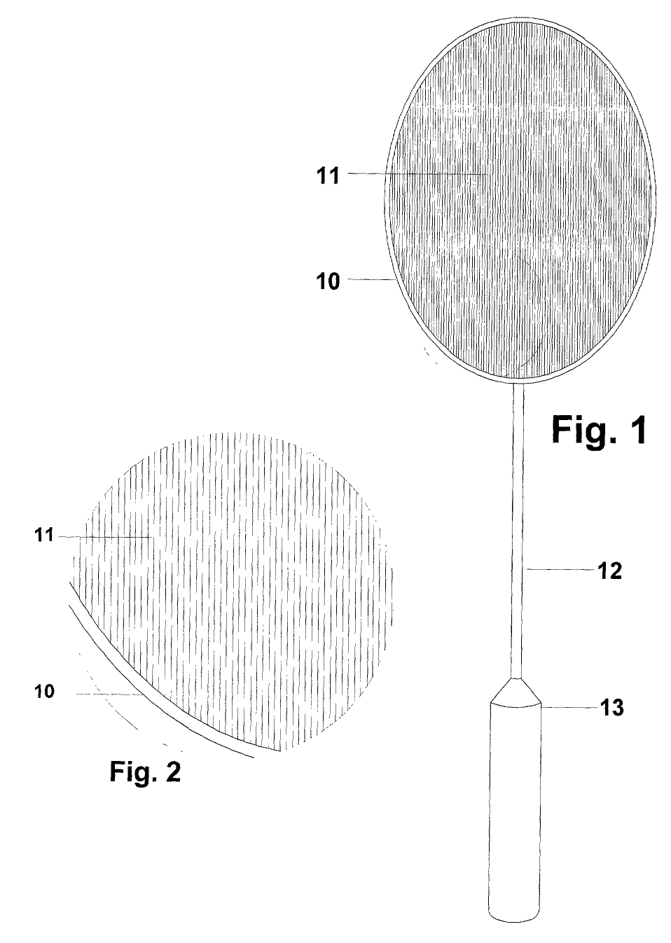

FIG. 1 shows a typical embodiment of a lightweight, long-handled racquet 10 having a more or less elliptical hoop 11 which is woven with closely spaced, tightly stretched, small diameter wires 12. The hoop 11 is attached via a handle extension 13 to a handle 14.

FIG. 2 shows an enlarged portion of the elliptical hoop 11 of the racquet showing the closely spaced wires 12 in a parallel arrangement.

The wire used in this embodiment is0.006″ stainless steel with about 12 wires per inch. The entire racquet frame, including the hoop, the handle extension and the handle, can be made in one piece from graphite composition compounds. The dimensions of the racquet are similar to a common badminton racquet with the overall length being about 26 inches and with the hoop being about 8 inches wide and 10 inches long. The hoop frame and handle extension components are about ¼ inch in diameter and the diameter of the handle is about 1 inch.

The description of the present invention contained herein is an exemplification of typical embodiments and is considered as illustrative only of the principles of this invention. Although this description contains various specificities, these should not be construed as limitations on the scope of this invention. The device of the present invention can be made with various materials and shapes. Other materials that can be used instead of stainless steel wire include various natural and synthetic fibers which could be braided strands or monofilament such as lightweight fishing line. The preferred embodiment shows 12 wires per inch; the device could have more or fewer wires per inch depending on the size of the target insect. The preferred embodiment shows the wires stretched parallel and without cross strands; other configurations that are not parallel may be used and cross strands may be included. The hoop could be padded to limit collateral damage or injury caused by the device. The hoop could be larger or smaller and it could be a shape other than an ellipse. The handle and the handle extension could be varying lengths and materials and the racquet frame could be made from various materials including steel and aluminum alloys.

Other changes in size, color, materials, shape, form, function and manner of operation, assembly and use, are deemed readily apparent and do not depart from the scope of the present invention which is limited only by the following claims and their legal equivalents.

The invention claimed is:

1. A means to kill or disable flying insects comprising a lightweight, rigid, long-handled racquet, having a hoop being woven with wires or other filaments and having a handle and a handle extension, and with the improvement comprising the combination of features:
(a) with said wires being closely spaced to insure that said flying insect will be hit by one or more of said wires when said racquet is swung to hit said insect, and
(b) with said wires being of a relative very small diameter and with a relative large space between them, so that said wires move through the air very easily without building up an advance air pressure wave, and so that said wire is difficult for said insect to see, and
(c) with said wires being inelastic and tightly stretched to become essentially rigid with said hoop and racquet, so that the momentum of said moving racquet is effectively transferred to the point of contact between said wires and said insect allowing the delivery of a concentrated and damaging blow to said insect whereby this combination of features provides a simple and effective means to kill or disable said flying insects.

2. A method of controlling flying insects comprising the steps of:
(a) providing a means to kill or disable flying insects comprising a lightweight, rigid, long-handled racquet, having a hoop being woven with wires or other filaments and having a handle and a handle extension, and with the improvement comprising the combination of features:
(a) with said wires being closely spaced to insure that said flying insect will be hit by one or more of said wires when said racquet is swung to hit said insect, and
(b) with said wires being of a relative very small diameter and with a relative large space between them, so that said wires move through the air very easily without building up an advance air pressure wave, and so that said wire is difficult for said insect to see, and
(c) with said wires being inelastic and tightly stretched to become essentially rigid with said hoop and racquet, so that the momentum of said moving racquet is effectively transferred to the point of contact between said wires and said insect allowing the delivery of a concentrated and damaging blow to said insect whereby this combination of features provides a simple and effective means to kill or disable said flying insects, and
(b) using said means to kill or disable said flying insects to control said flying insect population.
